(19) United States
(12) Patent Application Publication
(10) Pub. No.: US 2021/0125149 A1
(43) Pub. Date: Apr. 29, 2021

(54) ADAPTABILITY JOB VACANCIES MATCHING SYSTEM AND METHOD

(71) Applicant: Institute For Information Industry, Taipei (TW)

(72) Inventors: Han-Yen YU, Taipei (TW); Yi-Chi CHOU, Taipei (TW); Chun-Yen CHAO, Taipei (TW); Cheng-Yang TSAI, Taipei (TW)

(21) Appl. No.: 16/699,324

(22) Filed: Nov. 29, 2019

(30) Foreign Application Priority Data
Oct. 29, 2019 (TW) 108139057

(51) Int. Cl. G06Q 10/10; G06F 17/27; G06K 9/00; G10L 25/63

(52) U.S. Cl. CPC G06Q 10/1053; G10L 25/63; G06K 9/00335; G06F 17/27

(57) ABSTRACT

An adaptability job vacancies matching system and method are provided. The system performs the following operations: determining a target corpus based on the electronic resume; analyzing the electronic resume to generate a plurality of keyword sets; analyzing the keyword sets to generate an electronic resume score; generating a plurality of interview questions according to the keyword sets and a plurality of preset question sets corresponding to a target job category; transmitting an animation to a user device, the animation is related to the interview questions; receiving a response animation, the response animation is related to a response of each interview question; analyzing the response animation, and generating an interview question score of each interview question and a confidence score corresponding to each interview question; calculating an index score based on the electronic resume score, the interview question scores, and the confidence scores to generate a list of matching job vacancies.

### PRIORITY

This application claims priority to Taiwan Patent Application No. 108139057 filed on Oct. 29, 2019, which is hereby incorporated by reference in its entirety.

### FIELD

The present invention relates to a job vacancies matching system and method. More particularly, the job vacancies matching technology of the present invention generates a list of matching job vacancies by analyzing electronic resume information and simulated interview information of job seekers.

### BACKGROUND

With the rapid advancement of various industries, demands for various human resources in the job market are increasing day by day. Under such a tendency, recruitment units need to find suitable employees efficiently, and job seekers also want to know more about their advantages and positioning.

At present, there are many kinds of human-resource matching platforms in the market, and the matching process of traditional human-resource matching platforms (which is referred to as matching platforms hereinafter) is as follows: first, job seekers establish their own resumes and check the job categories they want to apply for. Next, the matching platform widely distributes the resumes of the job seekers to various recruitment units, and the recruitment units actively and manually browse the relevant information of the job seekers for evaluation. Finally, the recruitment units make an appointment with the job seekers for further interviewing.

However, in the aforementioned matching process, it is difficult for the recruitment units to accurately screen job seekers if they only make judgements from the resumes presented in a written form. Moreover, the recruitment units often find out that the job seekers do not meet the recruitment requirements of their job vacancies only after the job seekers have entered the final interview stage, resulting in the waste of resources and time. Therefore, the current traditional matching process is not only time-consuming and lengthy for the recruitment units, but also labor-consuming for job seekers.

Further speaking, for the recruitment units, in addition to the evaluation index of the professional ability, personality traits are also an important evaluation index for the recruitment units to evaluate whether the job seekers are suitable for the job vacancies. However, when judging the personality traits of job seekers, the traditional recruitment units usually only do personality tests with paper-based questions during interviews. The job seekers may go through a lot of repeated answering exercises, and then answer the personality traits that meet the needs of the recruitment units for the job vacancies and talent selection, which results in inaccurate test results and causes troubles to the recruitment units. Therefore, the traditional matching methods provided by the current matching platforms are still unable to effectively match job vacancies and talents for recruitment units, and they cannot provide effective information as a reference for job seekers.

Accordingly, an urgent need exists in the art to provide an adaptability job vacancies matching technology.

### SUMMARY

Provided is an adaptability job vacancies matching system which is connected with a user device through a network, and the user device is operated by a job seeker. The adaptability job vacancies matching system may comprise a transceiving interface, a storage and a processor, wherein the processor is electrically connected to the transceiving interface and the storage. The storage stores a plurality of corpora and a job vacancies database, wherein the corpora are related to one of a plurality of job categories, the job vacancies database comprises a plurality of job vacancies, each of the job vacancies is related to one of the job categories, each of the job vacancies corresponds to a preset question set, and each of the preset question sets is generated by at least one recruitment unit. The processor receives an electronic resume from the user device. The processor determines a target corpus based on the electronic resume, wherein the target corpus is one of the corpora, and the target corpus is related to a target job category. The processor analyzes the electronic resume based on the target corpus to generate a plurality of first keyword sets, wherein the first keyword sets are related to the contents of a plurality of fields in the electronic resume. The processor analyzes the first keyword sets based on the target corpus to generate an electronic resume score. The processor generates a plurality of interview questions according to the first keyword sets and the preset question sets corresponding to the target job category, wherein the interview questions comprise a plurality of professional questions and a plurality of personality questions. The processor transmits an animation to a display interface of the user device, wherein the animation is related to the interview questions. The processor receives a response animation from the user device, wherein the response animation is related to a response of each interview question. The processor analyzes the response animation and generates an interview question score for each of the interview questions and a confidence score corresponding to each of the interview questions. The processor calculates an index score according to the electronic resume score, the interview question scores and the confidence scores to generate a list of matching job vacancies.

Also provided is an adaptability job vacancies matching method which is adapted for use in an electronic device. The electronic device may comprise a transceiving interface, a storage and a processor. The storage stores a plurality of corpora and a job vacancies database, wherein the corpora are related to one of a plurality of job categories, the job vacancies database comprises a plurality of job vacancies, each of the job vacancies is related to one of the job categories, each of the job vacancies corresponds to a preset question set, and each of the preset question sets is generated by at least one recruitment unit.

The adaptability job vacancies matching method is executed by the processor and may comprise the following steps: receiving an electronic resume from the user device; determining a target corpus based on the electronic resume, wherein the target corpus is one of the corpora, and the target corpus is related to a target job category; analyzing the electronic resume based on the target corpus to generate a plurality of first keyword sets, wherein the first keyword sets are related to the contents of a plurality of fields in the electronic resume; analyzing the first keyword sets based on the target corpus to generate an electronic resume score; generating a plurality of interview questions according to the first keyword sets and the preset question sets corresponding to the target job category, wherein the interview questions comprise a plurality of professional questions and a plurality of personality questions; transmitting an animation to a display interface of the user device, wherein the animation is related to the interview questions; receiving a response animation from the user device, wherein the response animation is related to a response of each interview question; analyzing the response animation and generating an interview question score for each of the interview questions and a confidence score corresponding to each of the interview questions; and calculating an index score according to the electronic resume score, the interview question scores and the confidence scores to generate a list of matching job vacancies.

The adaptability job vacancies matching technology (at least comprising a system and a method) provided herein generates a score of an electronic resume of a job seeker by automatically analyzing the electronic resume of the job seeker. Then, the adaptability job vacancies matching technology generates interview questions suitable for the job seeker according to the electronic resume and preset questions prepared in advance for each job vacancy. Then, the adaptability job vacancies matching technology generates the audio-visual animation of the interview question through the virtual portrait technology to conduct a simulated interview with the job seeker. According to the audio-visual animation of the answer of the job seeker, the adaptability job vacancies matching technology automatically analyzes the response and confidence score of the job seeker to generate an interview question score. Finally, based on the score of the electronic resume and the score of the simulated interview of the job seeker, the adaptability job vacancies matching technology generates a list of matching job vacancies to solve the problem in the prior art that job vacancies cannot be effectively matched. In addition, the present invention can also provide a recommendation list to the recruitment units and provide relevant placement information for reference by the job seekers.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic architectural view depicting an adaptability job vacancies matching system according to a first embodiment;

FIG. 2 depicts a specific exemplary example of a job vacancies database;

FIG. 3 depicts a specific exemplary example of a classification table;

FIG. 4A depicts a specific exemplary example of an animation generated by the adaptability job vacancies matching system;

FIG. 4B depicts a specific exemplary example of a response animation generated by a user device; and

FIG. 5 is a part of a flowchart diagram of an adaptability job vacancies matching method according to a second embodiment.

### DETAILED DESCRIPTION

In the following description, an adaptability job vacancies matching system and method provided in the present invention will be explained with reference to certain example embodiments thereof. However, these example embodiments are not intended to limit the present invention to any specific environment, applications or particular implementations described in these example embodiments. Therefore, description of these example embodiments is only for purpose of illustration rather than to limit the scope of the present invention.

It should be appreciated that, in the following embodiments and the attached drawings, elements unrelated to the present invention are omitted from depiction; and dimensions of and dimensional scales among individual elements in the attached drawings are provided only for illustration, but not to limit the scope of the present invention.

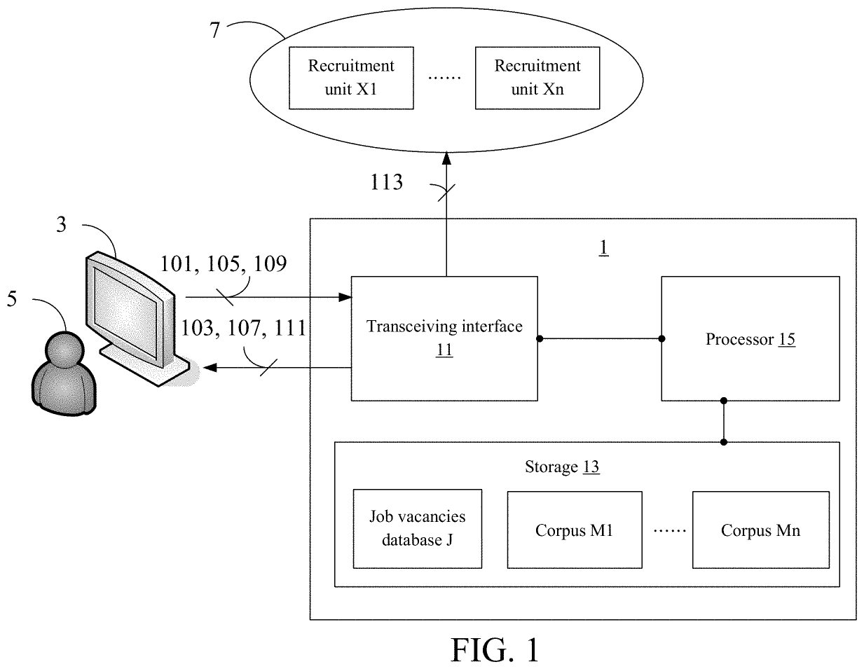

A first embodiment of the present invention is an adaptability job vacancies matching system 1, and a schematic view thereof is depicted in FIG. 1. In this embodiment, the adaptability job vacancies matching system 1 is connected to a user device 3 and a plurality of external devices 7 (i.e., devices used by a plurality of recruitment units X1, . . . , Xn) through a network, the user device 3 is operated by a job seeker 5, and the external devices 7 may be various computing devices used by each recruitment unit. It shall be noted that, the number of user devices 3 and the number of external devices 7 connected to the adaptability job vacancies matching system 1 are not limited by the present invention. In other words, in other embodiments of the present invention, the adaptability job vacancies matching system 1 may be connected to a plurality of user devices 3 and a plurality of authentication devices and external devices 7 through a network, depending on the scale and actual requirements of the adaptability job vacancies matching system 1.

The first embodiment of the present invention is an adaptability job vacancies matching system 1, and a schematic architecture view thereof is depicted in FIG. 1. The adaptability job vacancies matching system 1 comprises a transceiving interface 11, a storage 13 and a processor 15, and the processor 15 is electrically connected to the transceiving interface 11 and the storage 13. The transceiving interface 11 is an interface capable of receiving and transmitting data or other interfaces capable of receiving and transmitting data known to those of ordinary skill in the art. In this embodiment, the transceiving interface 11 serves as an information communication medium with the user device 3 and a plurality of external devices 7. The transceiving interface 11 is used for receiving and transmitting information such as electronic resumes, recommended job categories, target job categories, animations, response animations, lists of matching job vacancies, recommendation lists or the like. Specific details thereof will be described in the following paragraphs.

The storage 13 may be a memory, a universal serial bus (USB) disk, a hard disk, a compact disk (CD), a mobile disk or any other storage media or storage circuits having the same functions and well known to those of ordinary skill in the art. The processor 15 may be one of various processors, central processing units (CPUs), microprocessor units (MPUs), digital signal processors (DSPs) or other computing apparatuses well known to those of ordinary skill in the art. In some embodiments, the adaptability job vacancies matching system 1 may be separately disposed, or the adaptability job vacancies matching system 1 may be integrated into some computing servers, and this is not limited by the present invention.

First, the overall operation of this embodiment will be described. First, the adaptability job vacancies matching system receives an electronic resume from a user device, determines a target corpus (the target corpus is used for subsequent operations) according to the content of the electronic resume, and generates a written score (i.e., an electronic resume score). Then, the adaptability job vacancies matching system generates interview questions suitable for the job seeker according to the analyzed electronic resume and a preset question set pre-stored in the storage. Then, the adaptability job vacancies matching system generates an animation about the interview question according to the virtual portrait technology and transmits the animation to the user device for simulated interviewing. Next, the user device returns a response animation (including sound and images) about the interview question. Thereafter, the content of the response animation is analyzed by the adaptability job vacancies matching system to generate the question score and the confidence score corresponding to each interview question. Finally, the adaptability job vacancies matching system generates a list of matching job vacancies for the user device according to the electronic resume score and the score of the simulated interview. Specific details of each operation will be described in detail hereinafter.

In this embodiment, as shown in FIG. 1, the storage 13 of the adaptability job vacancies matching system 1 stores a plurality of corpora M1, . . . , Mn and a job vacancies database J in advance, where n is a positive integer greater than 2, and the corpora M1, . . . , Mn are related to one of a plurality of job categories (e.g., the corpus M1 is a corpus corresponding to the job category of “Salesman”, the corpus Mn is a corpus corresponding to the job category of “Engineer”, etc.).

Generally speaking, because abilities and standards to be evaluated vary in job vacancies of various job categories (e.g., salesman job vacancies pay more attention to the marketing and communication abilities of job seekers, and engineer job vacancies pay more attention to the logical abilities of job seekers), vocabularies and meanings appearing in various job categories should naturally be interpreted differently in different job categories. Therefore, the accuracy of matching can be improved if a specific corpus can be selected to assist the judgment according to the job categories for which the job seekers apply.

It shall be noted that, the corpus is established based on a large number of samples of the job category (e.g., electronic resumes, articles, matching data of historical job vacancies, relevant data on the network, etc.) and through machine learning. Therefore, the corpora M1, . . . , Mn contain information and functions about the meaning of vocabularies, the frequency of occurrence of vocabularies and the comparison of related words for the job category. It shall be noted that, the corpora M1, . . . , Mn can be built and trained by the adaptability job vacancies matching system 1 itself, or trained corpora can be directly received from an external device. Contents of the corpora shall be appreciated by those of ordinary skill in the art, and thus will not be further described herein.

In this embodiment, the job vacancies database J stored in the storage 13 comprises a plurality of job vacancies waiting to be matched, each of the job vacancies is related to one of the job categories (e.g., the job vacancy of “Software engineer of company A” corresponds to the job category of “Engineer”), each of the job vacancies corresponds to a preset question set, and each of the preset question sets is generated by at least one recruitment unit.

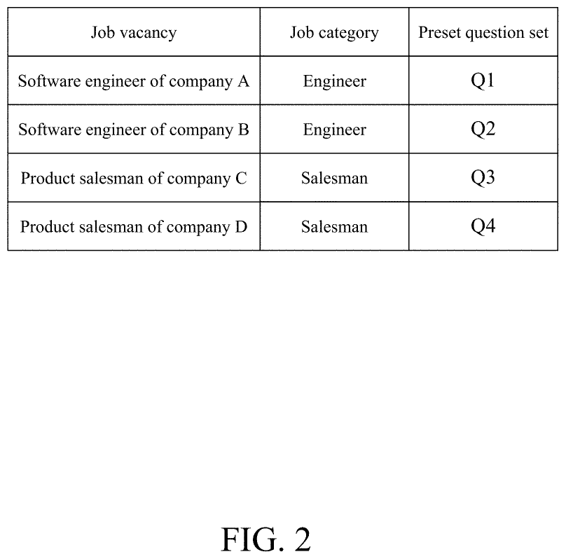

For ease of understanding, please refer to FIG. 2 for a specific exemplary example of a job vacancies database, but it is not intended to limit the exemplary example of the present invention. As shown in FIG. 2, the job vacancies database at least comprises fields such as Job vacancy, Job category, and Preset question set. The job vacancies database comprises four jobs vacancies such as “Software engineer of company A”, “Software engineer of company B”, “Product salesman of company C” and “Product salesman of company D”, which respectively correspond to job categories such as “Engineer”, “Engineer”, “Salesman” and “Salesman” and preset question sets such as “Q1”, “Q2”, “Q3” and “Q4”. In some embodiments, the preset question set previously stored in the storage 13 also comprises personality questions in addition to professional questions.

The preset question sets Q1 to Q4 are a plurality of interview questions designed by the recruitment unit for the job vacancy (e.g., the interview questions designed by the HR director of company A for the job vacancy of “Software engineer of company A”). Taking the preset question set Q1 in FIG. 2 as an example, the preset question set Q1 may comprise “Familiarity to JAVA language” and “Experience in software development”, while the preset question set of Q3 may be “Knowledge of products of company C” and “Opinions on sales strategies of company C”. It shall be noted that, the job vacancies database in FIG. 2 still contains other numerical values and relevant details not shown, which are for example: relevant contents of the job vacancies, the threshold for admission of the job vacancies, restriction conditions of the job vacancies or the like, and the contents thereof shall be appreciated by those of ordinary skill in the art, and thus only implementation details related to the present invention will be described in detail in the following paragraphs.

Referring to FIG. 1, the operations executed by the adaptability job vacancies matching system 1 will be described hereinafter. First, the adaptability job vacancies matching system 1 receives an electronic resume 101 from a user device 3. Next, the processor 15 determines a target corpus based on the electronic resume 101, wherein the target corpus is one of the corpora, and the target corpus is related to a target job category.

In some embodiments, the processor 15 may generate a plurality of recommended job categories 103 for the user device 3 from the job categories based on the electronic resume 101, and a job seeker 5 selects an interested job category (i.e., the target job category) from the recommended job categories 103. Next, the adaptability job vacancies matching system 1 receives the target job category 105 from the user device 3, the target job category 105 is one of the recommended job categories, and the processor 15 determines which corpus among the corpora M1, . . . , Mn should be used as the target corpus based on the received target job category 105.

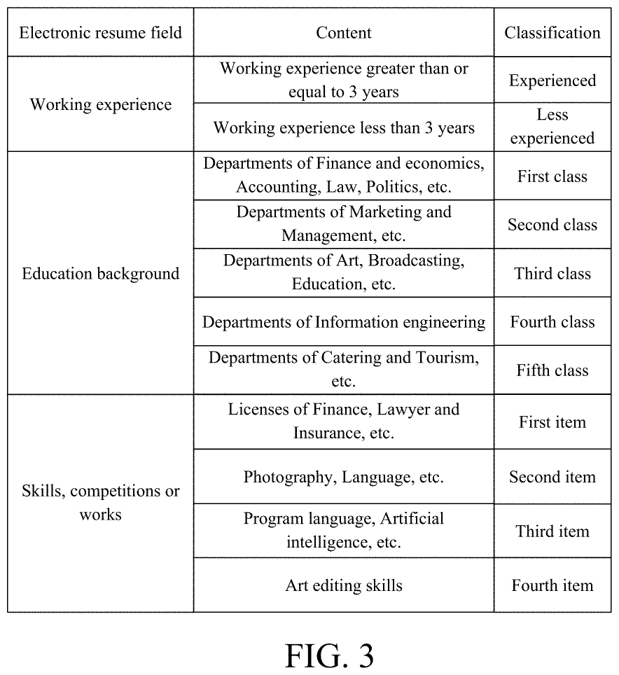

For ease of understanding, please refer to the specific exemplary example of a classification table in FIG. 3, but it is not intended to limit the exemplary example of the present invention. Based on this classification table, the processor 15 may compare contents of fields such as working experience, educational background, skills, competitions or works in the electronic resume 101 of the job seeker 5 to determine the job category suitable for the job seeker 5 and generate the suitable recommended job category 103 for the user device 3. Contents of generating a plurality of recommended job categories 103 and determining the content of the target job category 105 shall be appreciated by those of ordinary skill in the art based on the above description, and thus will not be further described herein.

Next, the adaptability job vacancies matching system 1 analyzes the written data of the job seeker 5 (i.e., the electronic resume 101), and retrieves relevant keywords from the written data of the job seeker 5 for subsequent written data scoring and generating interview questions. In this embodiment, the processor 15 analyzes the electronic resume 101 based on the target corpus to generate a plurality of first keyword sets, wherein the first keyword sets are related to the contents of a plurality of fields in the electronic resume.

Specifically, the processor 15 may perform word-segmenting processing (through, for example, the JIEBA word-segmenting program, etc.) respectively on the contents of the fields (e.g., working experience, education background, skills possessed, competitions or works, autobiography, etc.) in the electronic resume 101 of the job seeker 5 to generate word-segmenting results for the contents of the fields. Then, keyword extraction is performed on the word-segmenting result of the content of each of the fields through the target corpus to generate a first keyword set corresponding to each field. In some embodiments, the processor 15 further sets different weights for the keywords in each target corpus (e.g., increases the weight of keywords comprising “Java language”) to make adjustment based on requirements of each recruitment unit.

Next, the processor 15 analyzes the first keyword sets based on the target corpus to generate an electronic resume score. Specifically, the analysis of the first keyword sets by the processor 15 comprises the following operation: the processor 15 performs keyword comparison on the first keyword sets through the target corpus to generate the electronic resume score. For example, the processor 15 performs keyword comparison between each of the first keyword sets and the target corpus, and the electronic resume score may be realized by algorithms such as Best Match 25 (BM25), Term frequency-inverse document frequency (TF/IDF) or the like. In some embodiments, the processor 15 generates an electronic resume score including a learning experience index, a skill index, and a personality trait index according to each of the first keyword sets generated by the contents of the fields in the electronic resume 101 (e.g., working experience, education background, skills possessed, competitions or works, autobiography, etc.).

Then, after scoring the electronic resume, the adaptability job vacancies matching system 1 begins relevant operations of the simulated interview. In this embodiment, the adaptability job vacancies matching system 1 generates a plurality of interview questions specific to the job seeker 5 based on the processed electronic resume (i.e., the first keyword set) and the preset question sets corresponding to the target job category, wherein the interview questions comprise a plurality of professional questions and a plurality of personality questions. Therefore, the interview questions generated by the processor 15 may comprise both examination of professional questions and examination of personality questions.

Taking the example of FIG. 2 as an example, when the target job category applied by the job seeker 5 is “Engineer”, the processor 15 may select some of the questions from the preset question set Q1 or Q2 corresponding to the job category of “Engineer” as the interview questions. For example, the professional question is “Familiarity to JAVA language”, and the personality question is “Do you have a good communication ability in a team?”.

As another example, the processor 15 may also make questions based on the first keyword sets (i.e., make questions based on the keywords processed in the electronic resume 101 regarding education background, skills possessed, competitions or works, autobiographies, etc.). For example, the processor 15 may generate interview questions such as “What is the most difficult challenge faced when studying in a certain department?” according to the education background of the job seeker 5 or generate interview questions such as “Experience gained from participating in a competition” according to the competition or work of the job seeker 5.

Next, after the processor 15 has generated the interview questions, the processor 15 generates an animation 107 related to the interview questions through the virtual portrait technology. Subsequently, the processor 15 transmits the animation 107 to the display interface of the user device 3. Thereafter, the processor 15 receives a response animation 109 from the user device 3, and the response animation 109 is related to a response of each interview question.

Specifically, the processor 15 presents the interview questions through the virtual portrait technology, simulates the interviewer to ask the interview questions through a virtual image to generate the animation 107, and the animation 107 is displayed to the job seeker 5 through a display interface (e.g., a computer screen, a mobile phone screen, etc.) of the user device 3. Next, the job seeker 5 makes a response or answer based on the interview question (i.e., the animation 107), and records the image and speech of the job seeker 5 through the audio-visual capturing device (e.g., a camera and a microphone) of the user device 3 to generate the response animation 109, and the user device 3 then transmits the response animation 109 to the processor 15 for analysis. In some embodiments, the response animation 109 may also be uploaded by the job seeker 5 himself/herself after the job seeker 5 has recorded the response animation 109.

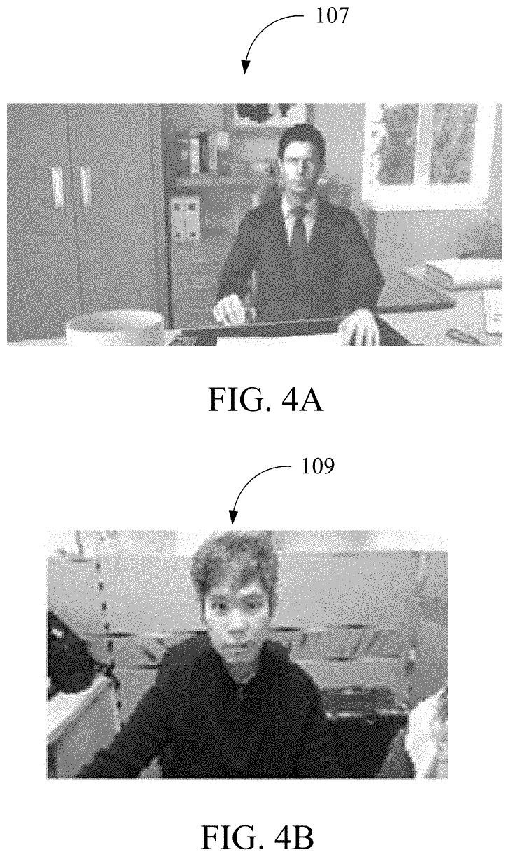

For ease of understanding, please refer to FIG. 4A and FIG. 4B for specific exemplary examples of the animation 107 and the response animation 109 respectively. As shown in FIG. 4A, the job seeker 5 conducts a simulated interview with the simulated interviewer through the display interface of the user device 3, and the job seeker 5 answers interview questions raised by the simulated interviewer. Next, after receiving the audio and video information of the job seeker 5 by the camera and the microphone of the user device 3, the response animation 109 is generated and transmitted back to the processor 15 to complete the simulated interview. It shall be noted that, those of ordinary skill in the art shall be familiar to contents and implementation details of the virtual portrait technology, and how to complete the virtual portrait technology is not the focus of the present invention, and thus will not be further described herein.

Subsequently, the processor 15 analyzes the response animation 109 to generate an interview question score for each interview question and a confidence score corresponding to each interview question. First, the method for scoring the interview questions will be explained. The processor 15 generates a corresponding text content for each of the interview questions in the response animation 109 through a Speech to Text technology. Next, similar to the operation of analyzing the electronic resume 101 by the processor 15, the processor 15 performs word-segmenting processing on the text content generated for each interview question to generate the word-segmenting result corresponding to each interview question. Subsequently, the processor 15 performs keyword extraction on each word-segmenting result through the target corpus to generate a second keyword set corresponding to each of the interview questions. Finally, keyword comparison is performed on each of the second keyword sets through the target corpus to generate each interview question score for each interview question. In some embodiments, each of the interview question scores generated by the processor 15 further comprises a learning experience index, a skill index and a personality trait index.

For example, the processor 15 performs keyword comparison between each of the second keyword sets and the target corpus, and the electronic resume score can be realized by algorithms such as Best Match 25 (BM25), Term frequency-inverse document frequency (TF/IDF) or the like.

Next, the method for calculating the confidence score corresponding to each of the interview questions is described. The processor 15 performs polygraph recognition on each of the interview questions of the response animation 109 to generate the confidence score corresponding to the interview question, wherein the polygraph recognition comprises a behavior analysis and a speech analysis. For example, if the answer to the interview question has a higher confidence score, then it means that the job seeker 5 is more confident about the answer to the interview question, and the answer may be closer to the real situation of the job seeker 5. On the contrary, if the answer to the interview question has a lower confidence score, then it means that the job seeker 5 has less confidence in the answer to the interview question and may even be lying.

Specifically, the polygraph recognition identifies whether the job seeker 5 is lying by analyzing facial expressions, gestures, mode and contents of the speech or the like of the job seeker 5, and behavior analysis mainly identifies the facial expressions of the subject. For example, when the subject (i.e., the job seeker 5) shows facial features such as one corner of his/her mouth raised, eyes slightly narrowed, and pupils narrowed or the like, then the behavior thereof is analyzed as “Contempt”. When the facial muscles of the subject are in a relaxed state with stable and uniform distribution and without major changes, the behavior thereof is analyzed as “Calm”. When corners of the mouth of the subject are raised, eyes thereof become smaller, and meanwhile corners of the eyes thereof are raised, the behavior thereof is analyzed as “Calm”.

Speech analysis is determined by calculating the speaking frequency and speaking speed of the subjects. For example, when the speech frequency of male or female subjects ranges from 164 Hz to 698 Hz and 220 Hz to 1100 Hz respectively, the speech analysis thereof is characterized by vitality, vigor and extroversion or the like. When the speaking speed is more than 160 words per minute, the speech analysis thereof is characterized by impatience, action and sensitivity. When the speaking speed is less than 80 words per minute, the speech analysis thereof is characterized by more careful thinking.

In some embodiments, polygraph recognition may be accomplished through a multimodal feature extraction step, a feature encoding step, and a classification step. For example, the multimodal feature extraction step is completed by identifying motion features, audio features and content script features in the response animation 109. Identifying the motion features comprises applying an Improved Dense Trajectory (IDT) in motion recognition and using motion dynamics to recognize facial micro-expressions. The identification of audio features is to analyze the audio features through the Mel-frequency Cepstral Coefficients (MFCC) and use a Gaussian Mixed Model (GMM) to construct an audio feature dictionary for all training videos. The content script features use Global Vectors for Word Representation (Glove) to encode the entire set of words in the video script into a vector of a fixed length.

Next, for the feature encoding step, an encoding manner of Fisher vectors is adopted to classify features of several variables (motions, audios, contents) into vectors of fixed lengths. Finally, in the classification step, through facial micro-expression prediction, the predicted score detected from the most predictive micro-expressions (e.g., frown, eyebrow lift, corner of the mouth raised, lip protrusion and head turning to the side) is used as the advanced feature of deception prediction, and the classification is applied to images to generate the confidence score. It shall be noted that, contents of polygraph recognition shall be appreciated by those of ordinary skill in the art according to the above description, and thus will not be further described herein.

Finally, the processor 15 calculates an index score according to the electronic resume score, the interview question scores and the confidence scores to generate a list of matching job vacancies 111. Specifically, the processor 15 may take the confidence score as a weight, and when the confidence score to the interview question is higher, a higher weight is given to the interview question score. On the contrary, when the confidence score to the interview question is lower, a lower weight (even 0) is given to the interview question score, and the interview score is calculated in this way. Next, the processor 15 calculates an index score based on the interview score and the electronic resume score generated in the aforementioned manner (for example, takes the average value of the interview score and the electronic resume score as the index score). Finally, the processor 15 compares the threshold values of the job vacancies corresponding to the target job category in the job vacancies database J according to the index score of the job seeker 5, and recommends the suitable job vacancy (e.g., the threshold values meeting the job vacancy) to the job seeker 5. In some embodiments, the index score comprises the learning experience index, the skill index and the personality trait index.

In some embodiments, the processor 15 further generates a recommendation list 113 for the recruitment units X1, . . . , Xn according to the index score. For example, the processor 15 may recommend a list of job seekers who rank in the top in the index score or a list of job seekers who meet the job vacancy requirements (i.e., meet various threshold values for the job vacancy) to the recruitment units.

In some embodiments, the processor 15 further generates a placement analysis to the user device 3 according to the index score, wherein the placement analysis is related to the electronic resume score, the interview question scores, and the confidence scores. For example, the processor 15 may count index scores (including the learning experience index, the skill index and the personality trait index) obtained by a plurality of job seekers, and generate corresponding placement analysis for the job seekers according to the statistical results to assist the job seekers in understanding the test results.

As can be known from the above description, the adaptability job vacancies matching system 1 provided by the present invention generates a score of an electronic resume of a job seeker by automatically analyzing the electronic resume of the job seeker. Then, the adaptability job vacancies matching system 1 generates interview questions suitable for the job seeker according to the electronic resume and preset questions prepared in advance for each job vacancy. Then, the adaptability job vacancies matching system 1 generates the audio-visual animation of the interview question through the virtual portrait technology to conduct a simulated interview with the job seeker. According to the audio-visual animation of the answer of the job seeker, the adaptability job vacancies matching system 1 automatically analyzes the response and confidence score of the job seeker to generate an interview question score. Finally, based on the score of the electronic resume and the score of the simulated interview of the job seeker, the adaptability job vacancies matching system 1 generates a list of matching job vacancies to solve the problem in the prior art that job vacancies cannot be effectively matched. In addition, the present invention can also provide a recommendation list to the recruitment units and provide relevant placement information for reference by the job seekers.

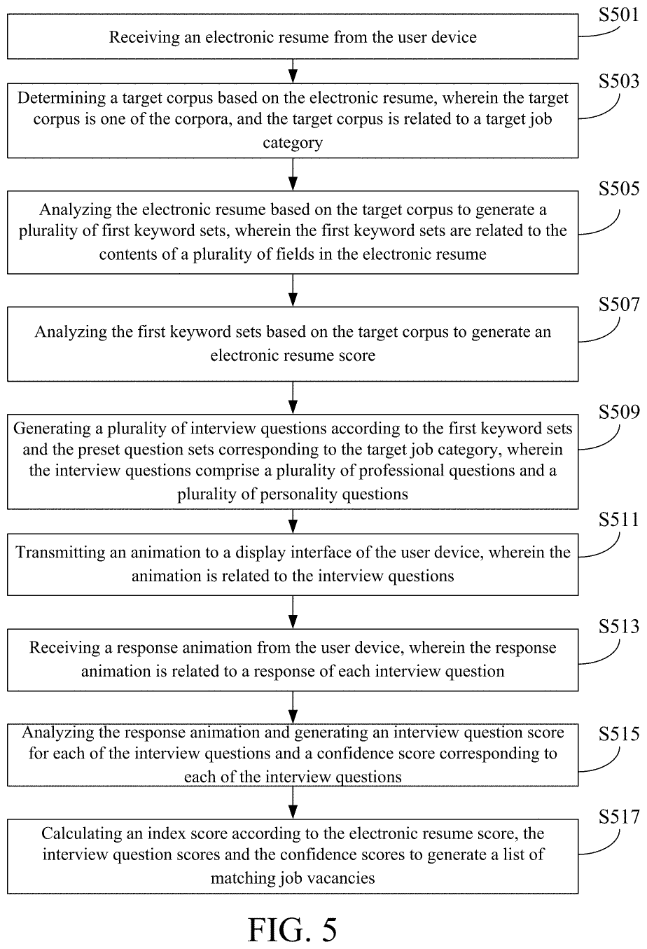

A second embodiment of the present invention is an adaptability job vacancies matching method, and a flowchart diagram thereof is depicted in FIG. 5. The adaptability job vacancies matching method is adapted for use in an electronic device (e.g., the adaptability job vacancies matching system 1 described in the first embodiment), the electronic device is connected with a user device through a network, and the user device is operated by a job seeker. The electronic device comprises a transceiving interface, a storage and a processor, the storage stores a plurality of corpora and a job vacancies database (e.g., the corpora M1, . . . , Mn and the job vacancies database J in the first embodiment), wherein the corpora are related to one of a plurality of job categories, the job vacancies database comprises a plurality of job vacancies, each of the job vacancies is related to one of the job categories, each of the job vacancies corresponds to a preset question set, each of the preset question sets is generated by at least one recruitment unit, and the adaptability job vacancies matching method is executed by the processor. The adaptability job vacancies matching method generates the list of matching job vacancies through steps S501 to S517.

In the step S501, the electronic device receives an electronic resume from the user device. In the step S503, the electronic device determines a target corpus based on the electronic resume, wherein the target corpus is one of the corpora, and the target corpus is related to a target job category.

Next, in the step S505, the electronic device analyzes the electronic resume based on the target corpus to generate a plurality of first keyword sets, wherein the first keyword sets are related to the contents of a plurality of fields in the electronic resume.

Thereafter, in the step S507, the electronic device analyzes the first keyword sets based on the target corpus to generate an electronic resume score.

Next, in the step S509, the electronic device generates a plurality of interview questions according to the first keyword sets and the preset question sets corresponding to the target job category, wherein the interview questions comprise a plurality of professional questions and a plurality of personality questions. Then, in the step S511, the electronic device transmits an animation to a display interface of the user device, and the animation is related to the interview questions.

Next, in the step S513, the electronic device receives a response animation from the user device, and the response animation is related to a response of each interview question. Next, in the step S515, the electronic device analyzes the response animation and generates an interview question score for each of the interview questions and a confidence score corresponding to each of the interview questions. Finally, in the step S517, the electronic device calculates an index score according to the electronic resume score, the interview question scores and the confidence scores to generate a list of matching job vacancies.

In some embodiments, determining the target corpus comprises the following steps: generating a plurality of recommended job categories to the user device based on the electronic resume; receiving the target job category from the user device, wherein the target job category is one of the recommended job categories; and determining the target corpus based on the target job category.

In some embodiments, analyzing the electronic resume comprises the following steps: performing word-segmenting processing on the content of each field in the electronic resume to generate a word-segmenting result for the content of each field; and performing keyword extraction on the word-segmenting result through the target corpus to generate the first keyword sets.

In some embodiments, analyzing the first keyword sets comprises the following step: performing keyword comparison on the first keyword sets through the target corpus to generate the electronic resume score.

In some embodiments, generating each of the interview question scores comprises the following steps: generating a text content for each of the interview questions from the response animation through a Speech to Text technology; performing word-segmenting processing on the text contents to generate a word-segmenting result corresponding to each of the interview questions; performing keyword extraction on each of the word-segmenting results through the target corpus to generate a second keyword set corresponding to each of the interview questions; and performing keyword comparison on each of the second keyword sets through the target corpus to generate each of the interview question scores for each of the interview questions.

In some embodiments, generating the confidence score corresponding to each of the interview questions comprises the following step: performing polygraph recognition for each interview question of the response animation to generate the confidence score corresponding to the interview question, wherein the polygraph recognition comprises a behavior analysis and a speech analysis.

In some embodiments, the interview question scores and the electronic resume score comprise a learning experience index, a skill index and a personality trait index.

In some embodiments, the method further comprises the following step: generating a recommendation list for the recruitment unit according to the index score. In some embodiments, the method further comprises the following step: generating a placement analysis to the user device according to the index score, wherein the placement analysis is related to the electronic resume score, the interview question scores and the confidence scores.

In addition to the aforesaid steps, the second embodiment can also execute all the operations and steps of the adaptability job vacancies matching system 1 set forth in the first embodiment, have the same functions and deliver the same technical effects as the first embodiment. How the second embodiment executes these operations and steps, have the same functions and deliver the same technical effects as the first embodiment will be readily appreciated by those of ordinary skill in the art based on the explanation of the first embodiment, and thus will not be further described herein.

It shall be appreciated that, in the specification and the claims of the present invention, some words (including the keyword set) are preceded by terms “first” or “second”, and these terms “first” and “second” are only used to distinguish different words. For example, the terms “first” and “second” in the first keyword set and the second keyword set are only used to represent keyword sets generated in different stages.

According to the above descriptions, the adaptability job vacancies matching technology (at least comprising a system and a method) provided by the present invention generates a score of an electronic resume of a job seeker by automatically analyzing the electronic resume of the job seeker. Then, the adaptability job vacancies matching technology generates interview questions suitable for the job seeker according to the electronic resume and preset questions prepared in advance for each job vacancy. Then, the adaptability job vacancies matching technology generates the audio-visual animation of the interview question through the virtual portrait technology to conduct a simulated interview with the job seeker. According to the audio-visual animation of the answer of the job seeker, the adaptability job vacancies matching technology automatically analyzes the response and confidence score of the job seeker to generate an interview question score. Finally, based on the score of the electronic resume and the score of the simulated interview of the job seeker, the adaptability job vacancies matching technology generates a list of matching job vacancies to solve the problem in the prior art that job vacancies cannot be effectively matched. In addition, the present invention can also provide a recommendation list to the recruitment units and provide relevant placement information for reference by the job seekers.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An adaptability job vacancies matching system, being connected with a user device through a network, the user device being operated by a job seeker, the adaptability job vacancies matching system comprising:
a transceiving interface;
a storage, being configured to store a plurality of corpora and a job vacancies database, wherein the corpora are related to one of a plurality of job categories, the job vacancies database comprises a plurality of job vacancies, each of the job vacancies is related to one of the job categories, each of the job vacancies corresponds to a preset question set, and each of the preset question sets is generated by at least one recruitment unit; and
a processor, being electrically connected to the transceiving interface and the storage and being configured to perform the following operations:
receiving an electronic resume from the user device;
determining a target corpus based on the electronic resume, wherein the target corpus is one of the corpora, and the target corpus is related to a target job category;
analyzing the electronic resume based on the target corpus to generate a plurality of first keyword sets, wherein the first keyword sets are related to the contents of a plurality of fields in the electronic resume;
analyzing the first keyword sets based on the target corpus to generate an electronic resume score;
generating a plurality of interview questions according to the first keyword sets and the preset question sets corresponding to the target job category, wherein the interview questions comprise a plurality of professional questions and a plurality of personality questions;
transmitting an animation to a display interface of the user device, wherein the animation is related to the interview questions;
receiving a response animation from the user device, wherein the response animation is related to a response of each interview question;
analyzing the response animation and generating an interview question score for each of the interview questions and a confidence score corresponding to each of the interview questions; and
calculating an index score according to the electronic resume score, the interview question scores and the confidence scores to generate a list of matching job vacancies.

2. The adaptability job vacancies matching system of claim 1, wherein determining the target corpus comprises the following operations:
generating a plurality of recommended job categories to the user device based on the electronic resume;
receiving the target job category from the user device, wherein the target job category is one of the recommended job categories; and
determining the target corpus based on the target job category.

3. The adaptability job vacancies matching system of claim 1, wherein analyzing the electronic resume comprises the following operations:
performing word-segmenting processing on the content of each field in the electronic resume to generate a word-segmenting result for the content of each field; and
performing keyword extraction on the word-segmenting result through the target corpus to generate the first keyword sets.

4. The adaptability job vacancies matching system of claim 1, wherein analyzing the first keyword sets comprises the following operation:
performing keyword comparison on the first keyword sets through the target corpus to generate the electronic resume score.

5. The adaptability job vacancies matching system of claim 1, wherein generating each of the interview question scores comprises the following operations:
generating a text content for each of the interview questions from the response animation through a Speech to Text technology;
performing word-segmenting processing on the text contents to generate a word-segmenting result corresponding to each of the interview questions;
performing keyword extraction on each of the word-segmenting results through the target corpus to generate a second keyword set corresponding to each of the interview questions; and
performing keyword comparison on each of the second keyword sets through the target corpus to generate each of the interview question scores for each of the interview questions.

6. The adaptability job vacancies matching system of claim 1, wherein generating the confidence score corresponding to each of the interview questions comprises the following operation:
performing polygraph recognition for each interview question of the response animation to generate the confidence score corresponding to the interview question, wherein the polygraph recognition comprises a behavior analysis and a speech analysis.

7. The adaptability job vacancies matching system of claim 1, wherein the interview question scores and the electronic resume score comprise a learning experience index, a skill index and a personality trait index.

8. The adaptability job vacancies matching system of claim 1, wherein the processor further generates a recommendation list for the recruitment unit according to the index score.

9. The adaptability job vacancies matching system of claim 1, wherein the processor further generates a placement analysis to the user device according to the index score, wherein the placement analysis is related to the electronic resume score, the interview question scores and the confidence scores.

10. An adaptability job vacancies matching method, being adapted for use in an electronic device, the electronic device being connected with a user device through a network, the user device being operated by a job seeker, the electronic device comprising a transceiving interface, a storage and a processor, the storage storing a plurality of corpora and a job vacancies database, wherein the corpora are related to one of a plurality of job categories, the job vacancies database comprises a plurality of job vacancies, each of the job vacancies is related to one of the job categories, each of the job vacancies corresponds to a preset question set, and each of the preset question sets is generated by at least one recruitment unit, the adaptability job vacancies matching method is executed by the processor and comprises:
receiving an electronic resume from the user device;
determining a target corpus based on the electronic resume, wherein the target corpus is one of the corpora, and the target corpus is related to a target job category;
analyzing the electronic resume based on the target corpus to generate a plurality of first keyword sets, wherein the first keyword sets are related to the contents of a plurality of fields in the electronic resume;
analyzing the first keyword sets based on the target corpus to generate an electronic resume score;
generating a plurality of interview questions according to the first keyword sets and the preset question sets corresponding to the target job category, wherein the interview questions comprise a plurality of professional questions and a plurality of personality questions;
transmitting an animation to a display interface of the user device, wherein the animation is related to the interview questions;
receiving a response animation from the user device, wherein the response animation is related to a response of each interview question;
analyzing the response animation and generating an interview question score for each of the interview questions and a confidence score corresponding to each of the interview questions; and
calculating an index score according to the electronic resume score, the interview question scores and the confidence scores to generate a list of matching job vacancies.

11. The adaptability job vacancies matching method of claim 10, wherein determining the target corpus comprises:
generating a plurality of recommended job categories to the user device based on the electronic resume;
receiving the target job category from the user device, wherein the target job category is one of the recommended job categories; and
determining the target corpus based on the target job category.

12. The adaptability job vacancies matching method of claim 10, wherein analyzing the electronic resume comprises:
performing word-segmenting processing on the content of each field in the electronic resume to generate a word-segmenting result for the content of each field; and
performing keyword extraction on the word-segmenting result through the target corpus to generate the first keyword sets.

13. The adaptability job vacancies matching method of claim 10, wherein analyzing the first keyword sets comprises:
performing keyword comparison on the first keyword sets through the target corpus to generate the electronic resume score.

14. The adaptability job vacancies matching method of claim 10, wherein generating each of the interview question scores comprises:
generating a text content for each of the interview questions from the response animation through a Speech to Text technology;
performing word-segmenting processing on the text contents to generate a word-segmenting result corresponding to each of the interview questions;
performing keyword extraction on each of the word-segmenting results through the target corpus to generate a second keyword set corresponding to each of the interview questions; and
performing keyword comparison on each of the second keyword sets through the target corpus to generate each of the interview question scores for each of the interview questions.

15. The adaptability job vacancies matching method of claim 10, wherein generating the confidence score corresponding to each of the interview questions comprises:
performing polygraph recognition for each interview question of the response animation to generate the confidence score corresponding to the interview question, wherein the polygraph recognition comprises a behavior analysis and a speech analysis.

16. The adaptability job vacancies matching method of claim 10, wherein the interview question scores and the electronic resume score comprise a learning experience index, a skill index and a personality trait index.

17. The adaptability job vacancies matching method of claim 10, further comprising:
generating a recommendation list for the recruitment unit according to the index score.

18. The adaptability job vacancies matching method of claim 10, further comprising:
generating a placement analysis to the user device according to the index score, wherein the placement analysis is related to the electronic resume score, the interview question scores and the confidence scores.
